(19) United States
(12) Patent Application Publication
(10) Pub. No.: US 2018/0100341 A1
(43) Pub. Date: Apr. 12, 2018

(54) GARAGE DOOR POSITION SENSING SYSTEM AND DEVICE

(71) Applicant: Upwardor Inc., Milton (CA)

(72) Inventor: Ryan Green, Brampton (CA)

(73) Assignee: Upwardor Inc.

(21) Appl. No.: 15/730,549

(22) Filed: Oct. 11, 2017

(30) Foreign Application Priority Data
Oct. 11, 2016 (US) 62406743

(51) Int. Cl. E05F 15/40; E05F 15/59

(52) U.S. Cl. CPC E05F 15/40; E05F 15/59; E05Y 2900/106; E05Y 2201/71; E05Y 2201/656

(57) ABSTRACT

A garage door position sensing system and devices includes an encoder assembly installed on a movable barrier door drive assembly, wherein the shaft associated with the barrier door drive assembly is positioned through a shaft interfacing portion of the encoder assembly and the shaft is operatively connected to the toothed pulley of the encoder assembly. A quadrature sensor is mounted within the encoder assembly, such that the sensing head of the sensor is fixed at a pre-determined distance from the teeth of the pulley. When the door moves from an open position to a closed position, and vice-versa, the pulley is rotated accordingly in response to the application of upward or downward forces on the shaft. The encoder assembly can be installed on any existing moveable barrier door and functions as a pneumatic door operator for sensing the position of travel without the need to use any mechanical switches.

### FIELD

The present disclosure relates to door operators and in particular to barrier door position sensing systems and devices which are mounted to existing overhead door hardware and which signal door position to a pneumatic door operator.

### BACKGROUND

Both magnetic and optical encoders are known and used in door operators (such as barrier doors, including garage doors) for sensing gate and door position throughout travel. In a traditional embodiment, encoders, both magnetic and optical, use a sensor head to pick up overlapping pulses from a rotating toothed pulley or perforated disk. The pulley or disk is rotated by an internal gear assembly or what is commonly known as a spring or a cable shaft. The spring or cable shaft will be further referred to as the shaft. As the operator moves the door into an open or closed position, the pulley or disk correspondingly rotates with the movement of the door. These sequential overlapping pulses are then received by the operator control circuit allowing said circuit to calculate the position to which the door has been moved to. What is desired is a novel door position sensing system and device which is mounted to existing overhead door hardware and which signals door position to a pneumatic door operator, and which overcomes noted deficiencies in prior art devices and systems.

### SUMMARY

It will be appreciated by those skilled in the art that other variations of the embodiments described below may also be practiced without departing from the scope of the invention. Further note, these embodiments, and other embodiments of the present invention, will become more fully apparent from a review of the description and claims which follow.

In one embodiment, the present invention relates to a unique rotary encoder of novel mounting and installation for position sensing and limit functions of a vertically operated access mechanism, such as a garage door. The unique design of the encoder and its mounting hardware allow installation to any door with a spring or cable shaft without modifications or use of complicated brackets, or other complex mounting mechanisms, and also enables a pneumatic door operator to sense position of travel without the need to use any mechanical switches or devices.

### BRIEF DESCRIPTION OF THE DRAWINGS

The embodiments herein will be understood from the following description with reference to the drawings, in which:

FIG. 1A illustrates a prior art shaft bearing.

FIG. 1B is a cross-sectional illustration of the inside of the encoder in accordance with one embodiment of the present invention.

FIG. 2 illustrates a perspective, partial exploded view of the unique installation and mounting of the encoder in accordance with one embodiment of the present invention.

In the drawings, preferred embodiments of the invention are illustrated by way of example. It is to be expressly understood that the drawings are only for the purpose of illustration and as an aid to understanding, and are not intended as a definition of the limits of the invention.

### DETAILED DESCRIPTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. In particular, all terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. Further, the stated features and/or configurations or embodiments thereof the suggested intent may be applied as seen fit to certain operating conditions or environments by one experienced in the field of the present invention.

In one embodiment, the present invention is a system and device comprised of a toothed pulley encased in a housing with mounting holes and a ferrous quadrature hall-effect sensor. The housing ensures that the pulley is centered between two mounting holes. The size and center to center distance of the mounting holes mimic the geometry and spacing of typical door shaft bearings and mounting plates that are a standard in the art. With additional hardware the encoder assembly mounts directly to the shaft and shaft bearing or bearing mounting plate. As the operator moves the door from an open position to a closed position, and vice-versa, the encoder pulley is rotated accordingly in response to the application of upward or downward forces on the door shaft.

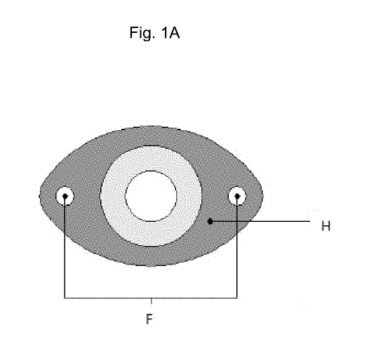

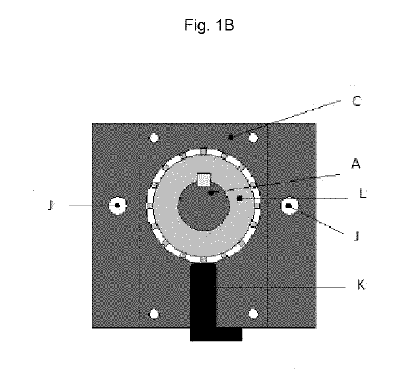

Now referring to the drawings, and initially to FIG. 1, in one embodiment, there is illustrated in FIG. 1B, an encoder or encoder assembly C (front elevation view) having a toothed pulley L inside a casing of the encoder assembly C. The pulley L is substantially centered between two mounting apertures J. The center-to-center distance and size of the mounting apertures J are machined to be the same distance apart and size as the mounting holes F of a typical shaft bearing G, which is illustrated as prior art (front elevation view) in FIG. 1A. In the encoder assembly embodiment shown in FIG. 1B, a quadrature sensor K is mounted in the encoder assembly C so that its sensing head is fixed at a pre-determined distance from the teeth of the pulley L. On installation of the encoder assembly C of FIG. 1A on to the shaft A of a barrier door drive assembly (not shown) associated with a movable barrier door (not shown), the shaft A is mechanically fixed to the toothed pulley L of the encoder assembly.

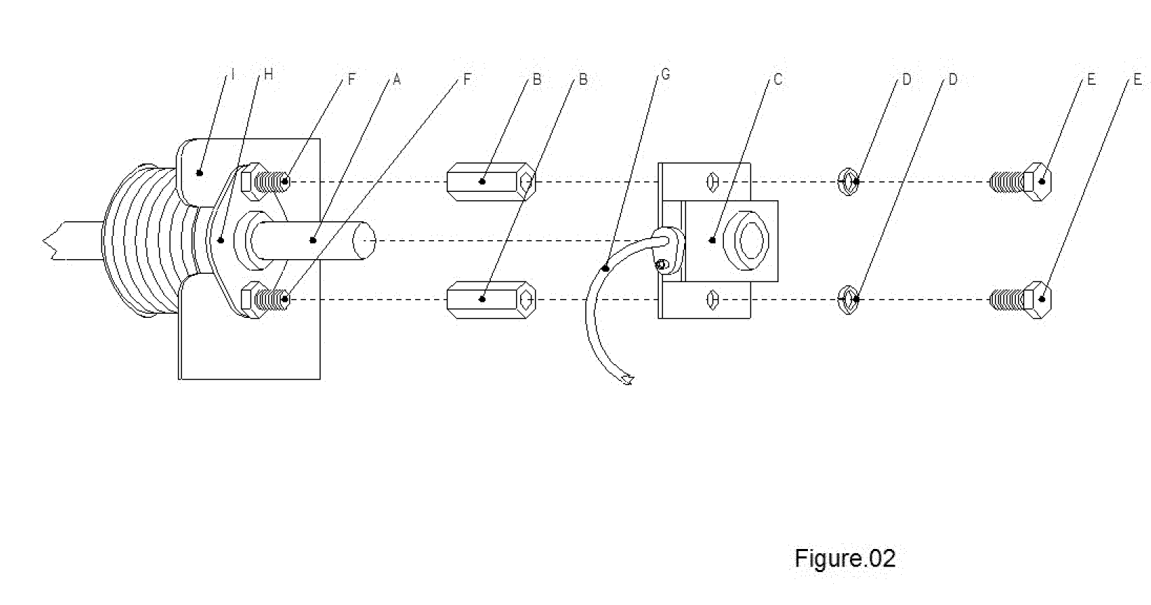

Referring next to FIG. 2, for reference, in the general art a shaft bearing H is disposed on a shaft A which is fixed to a mounting plate I by threaded fasteners F or other securement means. Note that elements I, H, F and A in FIG. 2 are prior art components which are part of the existing overhead garage door drive assembly (or other mechanical overhead barrier door) and do not form part of the present invention. In this regard, components of the drive assembly are commonly known to include a cable drum mounted on a shaft, and a drive unit having a motor which is connected to the shaft by a chain drive system, and the motor operates to rotate the shaft. The encoder assembly C of the present invention is secured around the shaft A overhang, of an existing installed drive assembly, as depicted in FIG. 2. The encoder assembly C may be affixed to the drive assembly by any suitable attachment mechanism. In the embodiment shown, two coupling nuts B are installed on the overhanging thread of each mounting fastener F of the drive assembly. In the embodiment shown, the encoder assembly includes two flange portions disposed on opposite sides of the shaft interfacing portion. The shaft interfacing portion includes an aperture (shaft aperture) for receiving the shaft A overhang of the drive assembly. Each flange portion includes a mounting apertures for interfacing with each mounting fastener F of the drive assembly. In the embodiment shown, since the overhang on each mounting fastener F is shorter than the shaft A overhang, the mounting apertures of each flange portion are brought into alignment with the mounting fasteners F and associated coupling nuts B, and bolts E and lock washers D and used to secure the encoder assembly C to the coupling nuts B and ultimately to the mounting fasteners F of the drive assembly. A wire G is associated with a sensor head on the encoder assembly C. The wire G is routed and connected to a control panel circuit for controlling operation of the encoder assembly C.

Referring back to FIG. 1B, in one embodiment, the interior of the shaft interfacing portion of the encoder assembly C comprises a toothed pulley L. As previously indicated, the pulley L is substantially centered between the two mounting apertures disposed on each flange portion of the encoder assembly C. When the encoder assembly C is installed on a movable barrier door drive assembly, the shaft A associated with the barrier door drive assembly is positioned through the shaft aperture disposed on the shaft interfacing portion of the encoder assembly C and the shaft A is operatively connected to the toothed pulley L of the encoder assembly, which surrounds the shaft aperture, such that the toothed pulley L rotates in response to rotational movement of the shaft A when force is applied to open or close the barrier door. A quadrature sensor K, such as a ferrous quadrature hall-effect sensor, or equivalent, is mounted within the casing of the encoder assembly C itself, such that the sensing head of the sensor K is fixed at a pre-determined distance from the teeth of the pulley L. In operation, as the operator moves the door from an open position to a closed position, and vice-versa, the pulley L is rotated accordingly in response to the application of upward or downward forces on the shaft A. The unique design of the encoder assembly of the present invention, includes its capability to be installed on effectively any pre-existing moveable barrier door having a drive assembly with a spring or cable shaft, without any modifications or use of complicated brackets, or other complex mounting means, and its function as a pneumatic door operator for sensing the position of travel without the need to use any mechanical switches or associated devices.

While one or more embodiments of this invention have been described above, it will be evident to those skilled in the art that changes and modifications can be made therein without departing from the essence of this invention. All such modifications are believed to be within the sphere and scope of the invention as defined by the claims appended hereto.

We claim:

1. The systems and methods as described generally in the preceding description.

2. The embodiments described in the preceding description.

3. Any other invention described in the preceding description.
